(19) United States
(12) Patent Application Publication
(10) Pub. No.: US 2018/0273684 A1
(43) Pub. Date: Sep. 27, 2018

(54) POLYOXAZOLIDINONE RESIN, PREPARATION METHOD THEREOF AND USE THEREOF IN IMPREGNATING VARNISH

(71) Applicant: Suzhou Taihu Electric Advanced Material Co, Ltd., Suzhou (CN)

(72) Inventors: BIN WU, SUZHOU (CN); CHUNQI ZHANG, SUZHOU (CN); FENGXI JING, SUZHOU (CN); JIANFENG GU, SUZHOU (CN); LURU JING, SUZHOU (CN); ZHIFENG XIA, SUZHOU (CN); JUNFENG MA, SUZHOU (CN)

(73) Assignee: Suzhou Taihu Electric Advanced Material Co, Ltd.

(21) Appl. No.: 15/996,489

(22) Filed: Jun. 3, 2018

Related U.S. Application Data
(63) Continuation of application No. PCT/CN2016/096209, filed on Aug. 22, 2016.

(30) Foreign Application Priority Data
Dec. 3, 2015 (CN) 201510874470.5

(51) Int. Cl. C08G 73/10; C08G 18/76; C08G 59/24; C09D 179/04

(52) U.S. Cl. CPC C08G 73/10; C09D 179/04; C08G 59/24; C08G 18/7621

(57) ABSTRACT

A polyoxazolidinone resin, a preparation method thereof and a use thereof in an impregnating varnish are provided. The polyoxazolidinone resin is prepared by reacting an alicyclic epoxy resin and a diisocyanate in the presence of a catalyst at 150° C. to 170° C. for 3 to 5 hours, wherein the molar ratio of the isocyanate radical in the diisocyanate to the epoxy radical in the alicyclic epoxy resin is 1:1.8 to 2.3. the impregnating varnish of the present invention uses the polyoxazolidinone resin as a bulk material in combination with acrylated epoxy resin and alicyclic epoxy resin, such that the impregnating varnish has the advantages of being heat resistant and flame retardant, low in cost, and eco-friendly, and finds use in insulation treatment of high-voltage and low-voltage electric machinery.

### CROSS-REFERENCE TO RELATED APPLICATIONS

This application is a continuation of International Patent Application No. PCT/CN2016/096209 with a filing date of Aug. 22, 2016, designating the United States, now pending, and further claims priority to Chinese Patent Application No. 201510874470.5 with a filing date of Dec. 3, 2015, designating the United States, now pending. The content of the aforementioned applications, including any intervening amendments thereto, are incorporated herein by reference.

### TECHNICAL FIELD

The present invention relates to a polyoxazolidinone resin, a preparation method thereof and a use thereof in an impregnating varnish.

### BACKGROUND OF THE PRESENT INVENTION

A winding in a motor has always been insulative-impregnated, in order to improve its operation safety, enhance its insulating performance and mechanical strength to avoid partial discharge resulted from internal air gap, enhance its operation reliability, prolong its service life, and improve its ability of moisture proof and salt resistance. At present, a vacuum pressure impregnation (VPI) technology is used by domestic motor manufacturers to insulate electrical machines such as motors and transformers. Therefore, the demand for VPI solvent-free impregnating resin is increasing in the market.

In recent years, the polyoxazolidinone resin has been applied in many cases because of its unique and excellent performance in heat resistance, chemical stability, water absorption, flame retardancy and so on. In the field of insulation, it has been used in laminate, copper clad plate and so on. The polyoxazolidinone resin is used to prepare impregnating varnish, the condensate of which has good dimensional stability, heat-resistant and flame-retardant properties. An impregnating varnish recipe containing a polyoxazolidinone resin is published in a Chinese patent numbered 201210050342.5, and the ingredients in weight including: 40-65 shares of unsaturated polyester resin solution with the solid concentration of 65%-75%; 15-35 shares of polyoxazolidinone resin solution with the solid concentration of 75%-85%; 10-25 shares of environmental-friendly diluent; 3-8 shares of curing agent; 1-3 shares of initiator; 0.01-0.06 shares of inhibitor.

In the existing solvent-free impregnating varnish with polyoxazolidinone resin, the polyoxazolidinone resin is used as an auxiliary resin instead of a main resin. It is because that, in the polyoxazolidinone resin, excessive universal epoxy resin and diisocyanate are generally used to produce a compound in which an epoxy sealed oxazone five-membered ring and a three azine six-membered ring are coexisted. Since the viscosity of the compound is high, the viscosity of the solvent-free impregnating varnish will be high if the varnish is mainly made of the resin. Therefore, the varnish can't be fully permeated the mica belt in the winding of the motor under the vacuum pressure, and the insulation performance is reduced as there is an air gap in insulation after curing.

### SUMMARY OF PRESENT INVENTION

The technical problem to be solved in the present invention is to provide a polyoxazolidinone resin, a preparation method thereof and a use thereof in an impregnating varnish, and the impregnating varnish has good heat-resistant and flame-resistant performances.

In order to solve the technical problem, the following technical scheme is provided in the present invention.

A preparation method for polyoxazolidinone resin is provided in the present invention. The polyoxazolidinone resin is prepared by reacting an alicyclic epoxy resin and a diisocyanate in the presence of a catalyst at 150° C. to 170° C. for 3 to 5 hours, wherein the molar ratio of the isocyanate radical in the diisocyanate to the epoxy radical in the alicyclic epoxy resin is 1:1.8 to 2.3.

Advantageously, the preparation method comprises the following detailed steps: the polyoxazolidinone resin is prepared by heating up to 150-170° C. in a stirring condition after adding the alicyclic epoxy resin and the catalyst into a reactor, and then dripping the diisocyanate with keeping the temperature for 3-5 hours.

Advantageously, the alicyclic epoxy resin comprises one or a combination of 3,4-epoxy cyclohexyl methyl, 3,4-epoxy cyclohexyl formate, 3,4-epoxy-6-methyl-cyclohexyl methyl-3,4-epoxy cyclohexyl formate, dual((3,4-epoxy cyclohexyl) methyl)oxalate, or dual((3,4-epoxy-6-methyl-cyclohexyl)methyl)oxalate; the diisocyanate comprises one or a combination of toluene diisocyanate, methylene diphenyl diisocyanate, hexane diisocyanate, isophorone diisocyanate, or diphenyl methylene diisocyanate.

Wherein, the structural formula of the 3,4-epoxy cyclohexyl methyl 3,4-epoxy cyclohexyl formate is represented as follows:

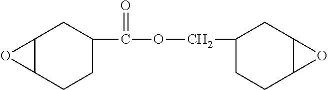 [SMILES: O=C(OCC1CCC2OC2C1)C1CCC2OC2C1]

The structural formula of the 3,4-epoxy-6-methyl-cyclohexyl methyl 3,4-epoxy cyclohexyl formate is represented as follows:

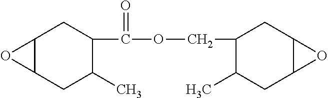 [SMILES: CC1CC2OC2CC1COC(=O)C1CC2OC2CC1C]

The structural formula of the dual((3,4-epoxy cyclohexyl) methyl)oxalate is represented as follows:

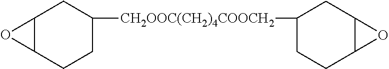

The structural formula of the dual((3,4-epoxy-6-methyl-cyclohexyl)methyl)oxalate is represented as follows:

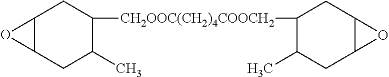

More advantageously, the alicyclic epoxy resin is 3,4-epoxy cyclohexyl methyl 3,4-epoxy cyclohexyl formate, the diisocyanate is toluene diisocyanate, the mass ratio of the 3,4-epoxy cyclohexyl methyl 3,4-epoxy cyclohexyl formate to the toluene diisocyanate is 1:0.3-0.5.

Advantageously, the catalyst comprises one or a combination of imidazole, lewis acid, or quaternary salt.

Advantageously, the lewis acid comprises one or two of magnesium chloride or zirconium chloride; the imidazole comprises one or two of 2-ethyl-4-methylimidazole or 2-phenylimidazole; the quaternary salt comprises one or two of tetrabutylphosphonium bromide, or tetraethylammonium bromide.

More advantageously, the catalyst comprises one or two of 2-ethyl-4-methylimidazole or 2-phenylimidazole.

Advantageously, the mass ratio of the catalyst to the alicyclic epoxy resin is 0.004-0.006:1.

A polyoxazolidinone resin prepared by the method in the present invention, the viscosity of the polyoxazolidinone resin at 25° C. is within 1500-3000 cps.

According to the present invention, the polyoxazolidinone resin has following structural characteristics:

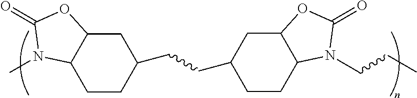

An impregnating varnish is provided in the present invention. Its ingredient recipe by weights is as follows:

| | | |
|---|---|---|
| the polyoxazolidinone resin | 100 | shares |
| a cycloaliphatic epoxy resin | 30-60 | shares |
| an acrylate epoxy resin | 20-45 | shares |
| a reactive diluent | 10-25 | shares |
| a curing agent | 2-8 | shares |
| an initiator | 0.5-1 | shares |
| an inhibitor | 0.5-1 | shares |

Advantageously, the reactive diluent comprises one or a combination of vinyltoluene, styrene, acrylate, or diallyl phthalate; the curing agent comprises one or a combination of chromium acetylacetonate, zirconium acetylacetonate, aluminium acetylacetonate, zinc octoate, or zinc naphthenate; and the initiator comprises peroxide type initiator.

More advantageously, the initiator is dicumyl peroxide (DCP).

Advantageously, the preparing method for the cycloaliphatic epoxy resin comprises: the cycloaliphatic epoxy resin is prepared by heating up to 110-130° C. after adding an epoxy resin, an inhibitor and a catalyst into a reactor, and then dripping an acrylic acid into the reactor with keeping the temperature for 20-40 min, and then heating up to 135° C.-145° C. and keeping the temperature until the test result of the acid value is below 0.5 mg/g, wherein, the weight ratio of the epoxy resin to the acrylic acid to the inhibitor to the catalyst is 900-1100:90-110:4-6:1.

Advantageously, the epoxy resin is E44 epoxy resin.

Advantageously, the catalyst comprises one or a combination of benzylamine, trialkylamine, or triphenyl phosphine; the inhibitor comprises one or a combination of benzenediol (HQ), p-methoxyphenol, p-benzoquinone, or p-tert-Butylcatechol.

A preparing method for the impregnating varnish is provided in the present invention. The impregnating varnish is prepared by adding the reactive diluent, the polyoxazolidinone resin, the cycloaliphatic epoxy resin, and the curing agent at 55° C.-65° C. into the combination where the inhibitor dissolved into the acrylate epoxy resin, and cooling down to 0° C.-40° C. after stirring evenly, and then stirring again after adding the initiator.

Following advantageous can be achieved by the implementation of above technical schemes in the present invention in comparison with the prior art:

A low-viscosity polyoxazolidinone resin is first made of alicyclic epoxy resin and diisocyanate in the present invention. The polyoxazolidinone resin has a low viscosity, a good manufacturability and a good thermostability. The preparation method for it is simple and easy, and the reacting conditions are gentle.

The insulating varnish in the present invention is mainly made of the polyoxazolidinone resin in combination with acrylated epoxy resin and alicyclic epoxy resin. As a result, the impregnating varnish has the advantages of being heat resistant and flame retardant, low in cost, and eco-friendly, and it can be used in insulation treatment of high-voltage and low-voltage electric machinery.

### DESCRIPTION OF THE DRAWINGS

FIG. 1 is an infrared spectrum of the polyoxazolidinone resin prepared according to the first embodiment.

### DETAILED DESCRIPTION OF PREFERRED EMBODIMENTS

The present invention will be further explained in combination with the following embodiments which are not limitations to the present invention. The following ingredients can be bought on market.

### A First Embodiment

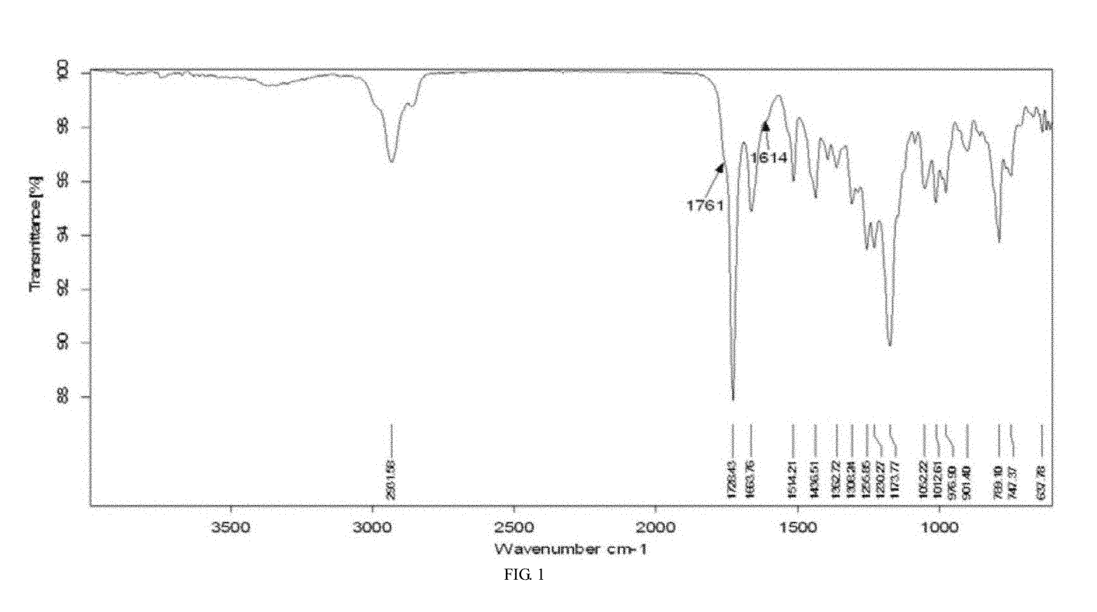

100 g 3,4-epoxy cyclohexyl methyl 3,4-epoxy cyclohexyl formate and 0.5 g 2-ethyl-4-methylimidazole are added into a reactor and stirred. 30.5 g toluene diisocyanate (TDI) is dripped into the reactor by drops after the temperature is risen to 160° C. The reactor is finished after keeping the temperature for 4 hours, and at the end, a polyoxazolidinone resin whose viscosity is measured as 1850 cps at 25° C. is obtained. FIG. 1 shows an infrared spectrum of the polyoxazolidinone resin. According to FIG. 1, the peak near 2900 cm-1 is a characteristic peak of C—H telescopic vibration, the peaks near 1614 cm-1 and 1514 cm-1 are characteristic peaks of benzene skeleton vibration, the peak near 1728 cm-1 is a telescopic vibration peak of the carbonyl connected to the alicyclic, the shoulder peak near 1761 cm-1 is a telescopic vibration peak of the carbonyl on the oxazolidinone ring, the peak near 901 cm-1 is a symmetric telescopic vibration peak of Epoxy ether bond C—O—C, and the peak near 2267 cm-1 which is the telescopic vibration peak of the isocyanate is completely disappeared. All these peaks demonstrate the success of the synthesis of the polyoxazolidinone resin.

### A First Contrastive Example

100 g 3,4-epoxy cyclohexyl methyl 3,4-epoxy cyclohexyl formate and 0.5 g 2-ethyl-4-methylimidazole are added into a reactor and stirred. 81.2 g toluene diisocyanate (TDI) is dripped into the reactor by drops after the temperature is risen to 160° C. The reactor is finished after keeping the temperature for 4 hours, and at the end, a polyoxazolidinone resin whose viscosity is measured as 8600 cps at 25° C. is obtained.

### A Second Contrastive Example

100 g 3,4-epoxy cyclohexyl methyl 3,4-epoxy cyclohexyl formate and 0.5 g 2-ethyl-4-methylimidazole are added into a reactor and stirred. 30.5 g toluene diisocyanate (TDI) is dripped into the reactor by drops after the temperature is risen to 190° C. The reactor is finished after keeping the temperature for 4 hours, and at the end, a polyoxazolidinone resin whose viscosity is measured as 11400 cps at 25° C. is obtained.

### A Second Embodiment

A solvent-free oxazolidinone impregnating varnish is provided in the embodiment, and its ingredient recipe by weights is as follows:

The Low-Viscosity Polyoxazolidinone Resin of the First Embodiment 100

| | |
|---|---|
| a cycloaliphatic epoxy resin | 50 |
| an acrylate epoxy resin | 30 |
| a vinyltoluene | 20 |
| a chromium acetylacetonate | 5 |
| an initiator DCP | 0.7 |
| an inhibitor HQ | 0.8 |

The preparing method for the solvent-free oxazolidinone impregnating varnish comprises following steps:

(1) a cycloaliphatic epoxy resin is prepared by: adding 100 g epoxy resin E44 into a reactor with stirring, and adding 0.5 g HQ as the inhibitor and 0.1 g benzylamine as the catalyst into the reactor; and dripping 10 g acrylic acid into the reactor after heating reactor to 120° C.; and heating up to 140° C. after keeping the temperature at 120° C. for 30 min, and finally keeping the temperature at 140° C. until the test result of the acid value is below 0.5 mg/g.

(2) the impregnating varnish is prepared by: adding 0.8 shares of HQ as the inhibitor into the product of step (1) and stirring to make the inhibitor dissolved into the product of step (1) at the temperature; and adding 20 shares of vinyltoluene, 100 shares of low-viscosity polyoxazolidinone resin, 50 shares of cycloaliphatic epoxy resin and 5 shares of chromium acetylacetonate into the reactor after cooling down to 60° C.; and cooling down to the room temperature after stirring the mixture thoroughly; and then stirring again after adding 0.7 shares of DCP as the initiator.

### A Third Embodiment

A solvent-free oxazolidinone impregnating varnish is provided in the embodiment, and its ingredient recipe by weights is as follows:

The Low-Viscosity Polyoxazolidinone Resin of the First Embodiment 100

| | |
|---|---|
| a cycloaliphatic epoxy resin | 50 |
| an acrylate epoxy resin | 30 |
| a vinyltoluene | 20 |
| a zirconium acetylacetonate | 5 |
| an initiator DCP | 0.7 |
| an inhibitor HQ | 0.8 |

The preparing method for the solvent-free oxazolidinone impregnating varnish comprises following steps:

(1) a cycloaliphatic epoxy resin is prepared by: adding 100 g epoxy resin E44 into a reactor with stirring, and adding 0.5 g HQ as the inhibitor and 0.1 g benzylamine as the catalyst into the reactor; and dripping 10 g acrylic acid into the reactor after heating reactor to 120° C.; and heating up to 140° C. after keeping the temperature at 120° C. for 30 min, and finally keeping the temperature at 140° C. until the test result of the acid value is below 0.5 mg/g.

(2) the impregnating varnish is prepared by: adding 0.8 shares of HQ as the inhibitor into the product of step (1) and stirring to make the inhibitor dissolved into the product of step (1) at the temperature; and adding 20 shares of vinyltoluene, 100 shares of low-viscosity polyoxazolidinone resin, 50 shares of cycloaliphatic epoxy resin and 5 shares of zirconium acetylacetonate into the reactor after cooling down to 60° C.; and cooling down to the room temperature after stirring the mixture thoroughly; and then stirring again after adding 0.7 shares of DCP as the initiator.

### A Third Contrastive Example

A solvent-free oxazolidinone impregnating varnish is provided in the example, and its ingredient recipe by weights is as follows:

| | |
|---|---|
| The low-viscosity polyoxazolidinone | 100 |
| of the first embodiment | |
| a cycloaliphatic epoxy resin | 50 |
| an acrylate epoxy resin | 30 |
| a vinyltoluene | 20 |
| a zirconium acetylacetonate | 15 |
| an initiator DCP | 0.7 |
| an inhibitor HQ | 0.8 |

The preparing method for the solvent-free oxazolidinone impregnating varnish comprises following steps:

(1) a cycloaliphatic epoxy resin is prepared by: adding 100 g epoxy resin E44 into a reactor with stirring, and adding 0.5 g HQ as the inhibitor and 0.1 g benzylamine as the catalyst into the reactor; and dripping 10 g acrylic acid into the reactor after heating reactor to 120° C.; and heating up to 140° C. after keeping the temperature at 120° C. for 30 min, and finally keeping the temperature at 140° C. until the test result of the acid value is below 0.5 mg/g.

(2) the impregnating varnish is prepared by: adding 0.8 shares of HQ as the inhibitor into the product of step (1) and stirring to make the inhibitor dissolved into the product of step (1) at the temperature; and adding 20 shares of vinyltoluene, 100 shares of low-viscosity polyoxazolidinone resin, 50 shares of cycloaliphatic epoxy resin and 15 shares of zirconium acetylacetonate into the reactor after cooling down to 60° C.; and cooling down to the room temperature after stirring the mixture thoroughly; and then stirring again after adding 0.7 shares of DCP as the initiator.

The performances of the impregnating varnished in the 2nd embodiment, the 3rd embodiment and the 4th contrastive example are measured according to GB/T 15023-1994 Test method for electrical-insulated solvent-free polymerizable resin, and the curing conditions are 140° C. for 3 h, 170° C. for 7 h. The measured performances are referred to the Table 1.

TABLE 1

| Item | | 2^{nd} embodiment | 3^{rd} embodiment | 4^{th} contrastive example |
|---|---|---|---|---|
| Appearance | | Light-yellow uniform | Light-yellow uniform | Light-yellow uniform |
| | | transparent liquid | transparent liquid | transparent liquid |
| Viscosity, [Paint 4 cup, 23° C.], | | 68 | 68 | 68 |
| second | | | | |
| Gelation time [Test tube | | 17 | 17.5 | 13 |
| method, 160° C., 10 g], min | | | | |
| Thick-layer curing ability [10 g, | | Better than | Better than | Better than |
| 170° C., 4 h] | | S1, U1, I2.1 | S1, U1, I2.1 | S1, U1, I2.1 |
| Solid volatile matter [10 g, | | 6 | 5.5 | 6.5 |
| 160° C., 4 h], % | | | | |
| Dielectric | Normality | 0.16% | 0.2% | 0.4% |
| loss | 155° C. | 3.6% | 3.4% | 4.8% |
| | 180° C. | 20% | 19% | 25% |

| | | | |
|---|---|---|---|
| Electric strength (Normality), | 26 | 24 | 25 |
| kV/mm | | | |
| Storage stability, 50° C. 96 h, | Change from | Change from | Change from |
| closed, viscosity change | 68 s to 77 s | 68 s to 75 s | 68 s to 132 s |

In order to make the people familiar with the field understand and implement the present invention, detailed descriptions which are not limitations to the present invention are given above. The equivalents or modifications made according to the spirit of the present invention should fall into the scope of the present invention.

We claim:

1. A preparation method for polyoxazolidinone resin, wherein, the polyoxazolidinone resin is prepared by reacting an alicyclic epoxy resin and a diisocyanate in the presence of a catalyst at 150° C. to 170° C. for 3 to 5 hours, wherein the molar ratio of the isocyanate radical in the diisocyanate to the epoxy radical in the alicyclic epoxy resin is 1:1.8 to 2.3.

2. The preparation method for polyoxazolidinone resin of claim 1, wherein, the preparation method comprises the following detailed steps: the polyoxazolidinone resin is prepared by heating up to 150-170° C. in a stirring condition after adding the alicyclic epoxy resin and the catalyst into a reactor, and then dripping the diisocyanate with keeping the temperature for 3-5 hours.

3. The preparation method for polyoxazolidinone resin of claim 1, wherein, the alicyclic epoxy resin comprises one or a combination of 3,4-epoxy cyclohexyl methyl 3,4-epoxy cyclohexyl formate, 3,4-epoxy-6-methyl-cyclohexyl methyl 3,4-epoxy cyclohexyl formate, dual((3,4-epoxy cyclohexyl) methyl)oxalate, or dual((3,4-epoxy-6-methyl-cyclohexyl)methyl)oxalate; the diisocyanate comprises one or a combination of toluene diisocyanate, methylene diphenyl diisocyanate, hexane diisocyanate, isophorone diisocyanate, or diphenyl methylene diisocyanate; and the catalyst comprises one or a combination of imidazole, lewis acid, or quaternary salt.

4. The preparation method for polyoxazolidinone resin of claim 3, wherein, the lewis acid comprises one or two of magnesium chloride or zirconium chloride; the imidazole comprises one or two of 2-ethyl-4-methylimidazole or 2-phenylimidazole; the quaternary salt comprises one or two of tetrabutylphosphonium bromide, or tetraethylammonium bromide.

5. A polyoxazolidinone resin prepared by the method of claim 1, wherein, the viscosity of the polyoxazolidinone resin at 25° C. is within 1500-3000 cps.

6. An impregnating varnish, wherein, its ingredient recipe by weights is as follows:

| | | |
|---|---|---|
| the polyoxazolidinone resin of claim 5 | 100 | shares |
| a cycloaliphatic epoxy resin | 30-60 | shares |
| an acrylate epoxy resin | 20-45 | shares |
| a reactive diluent | 10-25 | shares |
| a curing agent | 2-8 | shares |
| an initiator | 0.5-1 | shares |
| an inhibitor | 0.5-1 | shares |

7. The impregnating varnish of claim 6, wherein, the reactive diluent comprises one or a combination of vinyltoluene, styrene, acrylate, or diallyl phthalate; the curing agent comprises one or a combination of chromium acetylacetonate, zirconium acetylacetonate, aluminium acetylacetonate, zinc octoate, or zinc naphthenate; and the initiator comprises peroxide type initiator.

8. The impregnating varnish of claim 6, wherein, the preparing method for the cycloaliphatic epoxy resin comprises: the cycloaliphatic epoxy resin is prepared by heating up to 110-130° C. after adding an epoxy resin, an inhibitor and a catalyst into a reactor, and then dripping an acrylic acid into the reactor with keeping the temperature for 20-40 min, and then heating up to 135-145° C. and keeping the temperature until the test result of the acid value is below 0.5 mg/g, wherein, the weight ratio of the epoxy resin to the acrylic acid to the inhibitor to the catalyst is 900-1100:90-110:4-6:1.

9. The impregnating varnish of claim 6, wherein, the catalyst comprises one or a combination of benzylamine, trialkylamine, or triphenyl phosphine; the inhibitor comprises one or a combination of benzenediol, p-methoxyphenol, p-benzoquinone, or p-tert-Butylcatechol.

10. A preparing method for the impregnating varnish of claim 6, wherein, the impregnating varnish is prepared by adding the reactive diluent, the polyoxazolidinone resin, the cycloaliphatic epoxy resin, and the curing agent at 55-65° C. into the combination where the inhibitor dissolved into the acrylate epoxy resin, and cooling down to 0-40° C. after stirring evenly, and then stirring again after adding the initiator.
